(19) United States
(12) Patent Application Publication
(10) Pub. No.: US 2014/0143081 A1
(43) Pub. Date: May 22, 2014

(54) Interactive Online Auction System

(71) Applicant: NextLot, Inc., Raleigh, NC (US)

(72) Inventors: Scott Daryl Finkelstein, Raleigh, NC (US); Matthew Brian Henderson, Raleigh, NC (US); Emily Finkelstein, Raleigh, NC (US)

(73) Assignee: NextLot, Inc., Raleigh, NC (US)

(21) Appl. No.: 14/080,932

(22) Filed: Nov. 15, 2013

Related U.S. Application Data
(60) Provisional application No. 61/727,146, filed on Nov. 16, 2012.

(51) Int. Cl. G06Q 30/08

(52) U.S. Cl. CPC G06Q 30/08
USPC 705/26.3

(57) ABSTRACT

Techniques and apparatus for conducting a timed, online auction are described. In an example method, implemented in a server apparatus configured for communication with one or more network-connected user devices, current bidding information, for at least one item for sale, is sent to the one or more network-connected user devices, during an initial portion of a timed online auction event. Beginning at a predetermined time before termination of the auction event for the item, the server apparatus determines that one or more auction users have selected to participate in an interactive mode, and maintains a virtual auction room for participating users. This maintaining of the virtual auction room includes generating animation sequences based on bidding activity received from the participating users and sending the generated animation sequences to network-connected user devices corresponding to the participating users.

### RELATED APPLICATIONS

This application claims the benefit of and priority to U.S. Provisional Application Serial No. 61/727,146, filed 16 Nov. 2012, the entire contents of which are incorporated herein by reference.

### TECHNICAL FIELD

The present disclosure is related to online auction systems, and is more particularly related to online auction systems utilizing interactive multimedia components.

### BACKGROUND

Several methods have evolved for conducting a live auction online, e.g., over the Internet. Like traditional in-person auctions, a live online auction consists of a bidding session over a relatively short period of time, and resembles a bidding session at an in-person auction sale in several ways. However, the bidding takes place over a computer network, i.e., between a server and one or more network-connected user devices, rather than in person.

U.S. Pat. No. 7,617,145 (hereinafter “the '145 Patent”), issued 10 Nov. 2009, the entire contents of which are incorporated herein by reference, describes an online auction system in which bidders place bids on auction lots in the auction by using one or more predetermined bid increments provided by the system. The system provides for adjustment of the predetermined bid increments during the auction of a specific lot, in response to a determination that a pre-determined amount of time has elapsed since a bid was placed. This approach is intended to increase bid activity and optimize the auction result.

U.S. patent application Ser. No. 13/771,583 (hereinafter “the '583 application”), the entire contents of which are incorporated herein by reference, is entitled “Timed Online Auction Events” and was filed 20 Feb. 2013. The '583 application describes an online auction system that employs a proprietary, specific algorithm, indecipherable to bidders, to automatically change bid increments in a timed, on-line setting. In several embodiments of this system, the algorithm adjusts the increment value due to a combination of two factors: (1) how much time is left in the auction and (2) the percentage of a target price for the auctioned item represented by a most recent (i.e., “current”) bid. Further, in some embodiments the increments drop at random times so the bidder is unable to figure out the pattern. So, as items approach reserve prices as the auction winds down, increments will drop by unpredictable amounts and at unpredictable times, to generate more excitement for items and to bring higher prices.

The techniques described in the '583 application can be used to improve the online auction experience for users and to increase revenues for auctioneers. However, improved online auction techniques to further stimulate bidding activity are needed.

### SUMMARY OF THE INVENTION

Embodiments of the present invention improve the timed-online auction environment to more closely simulate a live-onsite auction by incorporating an interactive bid mode. The interactive bid mode uses multimedia components to present a virtual auction room to a bidder via the bidder's network-connected terminal, whether that terminal is a conventional personal computer, tablet computer, smartphone, or other device. These multimedia components include animated graphics and may also include audio and/or video components.

In various embodiments, the virtual auction room presented to the bidder comprises one or several of the following features:
an animated depiction of an auction room, in some cases based on a user-selected “skin” or template;
an animated avatar for the bidder, i.e., a graphical representation of the bidder or the bidder's alter ego, in some cases depicted according to user-customizable physical and/or behavioral features;
animated avatars for one or more other bidders, where each avatar corresponding to a bidder raises a bid paddle or performs some other activity to indicate bidding activity by the corresponding bidder;
an animated auctioneer, coupled to either a plurality of pre-recorded audio segments that are automatically retrieved and played back in response to bidder input or coupled to synthesized audio generated in response to bidder input;
still image, video, audio, and/or textual representations of the current lot;
graphical representations and/or text indicating time left in current lot;
graphical representations and/or text indicating time or times to one or more upcoming lots and/or the items in one or more upcoming lots;
a “chat” interface providing the ability for private communication between an auction representative and a bidder, and/or communication between an auction representative and all bidders, and/or communication between two or more bidders;
a “bid” button that, when clicked, submits a bid for the asking price on behalf of the user who initiates the request.

In some embodiments, the interactive mode described above is first initiated during an ongoing timed-online auction at a predetermined time before termination of the auction event for a given lot. In some of these and in other embodiments, a user (bidder) is given a choice as to whether to participate in interactive mode or in a conventional online bidding mode. Accordingly, the virtual auction room interface presented to users in interactive mode may include a selector button or other input mechanism that allows the user to switch to conventional bidding mode.

Any of the embodiments summarized above may be combined with automatic bid-time extension, based on bidding activity. Likewise, any of these embodiments may also incorporate the techniques for automatic bid-increment determination described in the '583 application (incorporated by reference above), e.g., so that the bidding system adjusts the increment value due to a combination of two factors: (1) how much time is left in the auction and (2) the percentage of a target price for the auctioned item represented by a most recent (i.e., “current”) bid.

Embodiments of the invention include methods according to one or more of the above techniques, as implemented by an auction web site comprising at least one processing circuit in a web server. In an example method, implemented in a server apparatus configured for communication with one or more network-connected user devices, current bidding information, for at least one item for sale, is sent to the one or more network-connected user devices, during an initial portion of a timed online auction event. Beginning at a predetermined time before termination of the auction event for the item, the server apparatus determines that one or more auction users have selected to participate in an interactive mode, and maintains a virtual auction room for participating users. This maintaining of the virtual auction room includes generating animation sequences based on bidding activity received from the participating users and sending the generated animation sequences to network-connected user devices corresponding to the participating users.

In some embodiments, maintaining the virtual auction room for participating users comprises, in response to bid information received from a first participating user, generating an animation sequence that includes animated actions carried out by a graphical avatar corresponding to the first participating user, for sending to the network-connected user devices corresponding to the participating users. In some of these and in some other embodiments, maintaining the virtual auction room comprises generating audio data or retrieving prerecorded audio data, or both, in response to bidding activity received from the participating users, and sending the audio data to network-connected user devices corresponding to the participating users. In some embodiments, maintaining the virtual auction room for participating users comprises generating a user-specific graphical representation of the virtual auction room for at least one participating user, wherein the user-specific graphical representation is based on the at least one participating user's prior selection of one of a plurality of presentation templates.

In some embodiments, the server apparatus continues to send, until expiration of the auction event for the item, current bidding information to network-connected devices corresponding to auction users that have bid on the item but that have not selected to participate in the interactive mode. In some of these and in some other embodiments, the server compares bids received from the participating users, during said maintaining of the virtual auction room, to one or more bids received from an auction user prior to the maintaining of the virtual auction room. Accordingly, not all auction participants are required to participate in the interactive portion of the timed online auction.

Other embodiments include server apparatus configured to carry out one or more of these methods, the server apparatus comprising a network interface circuit configured for communication with one or more network-connected user devices and further comprising a processing circuit configured to carry out one or more of the techniques summarized above.

### BRIEF DESCRIPTION OF THE DRAWINGS

FIG. 1 illustrates an example network, comprising an auction web server configured according to the present invention and several network-connected user devices.

FIG. 2 is a process flow diagram illustrating an example method for conducting a timed online auction event that includes an animated interactive mode.

FIG. 3 is a process flow diagram illustrating another example method for conducting a timed online auction event that includes an animated interactive mode.

FIG. 4 illustrates an example apparatus configured to carry out one or more of the techniques disclosed herein.

### DETAILED DESCRIPTION

U.S. Pat. No. 7,617,145, titled “Adaptive Bidding Increments in an Online Auction System” and issued 10 Nov. 2009 (hereinafter referred to as “the '145 Patent”), describes systems and methods for conducting an online auction. The entire contents of the '145 Patent are incorporated herein by reference for the purpose of providing background and context for the inventive techniques detailed herein. Likewise, the '583 application describes further systems and methods for conducting an online auction. The entire contents of the '583 application are also incorporated herein by reference for the purpose of providing background and context for the techniques detailed herein.

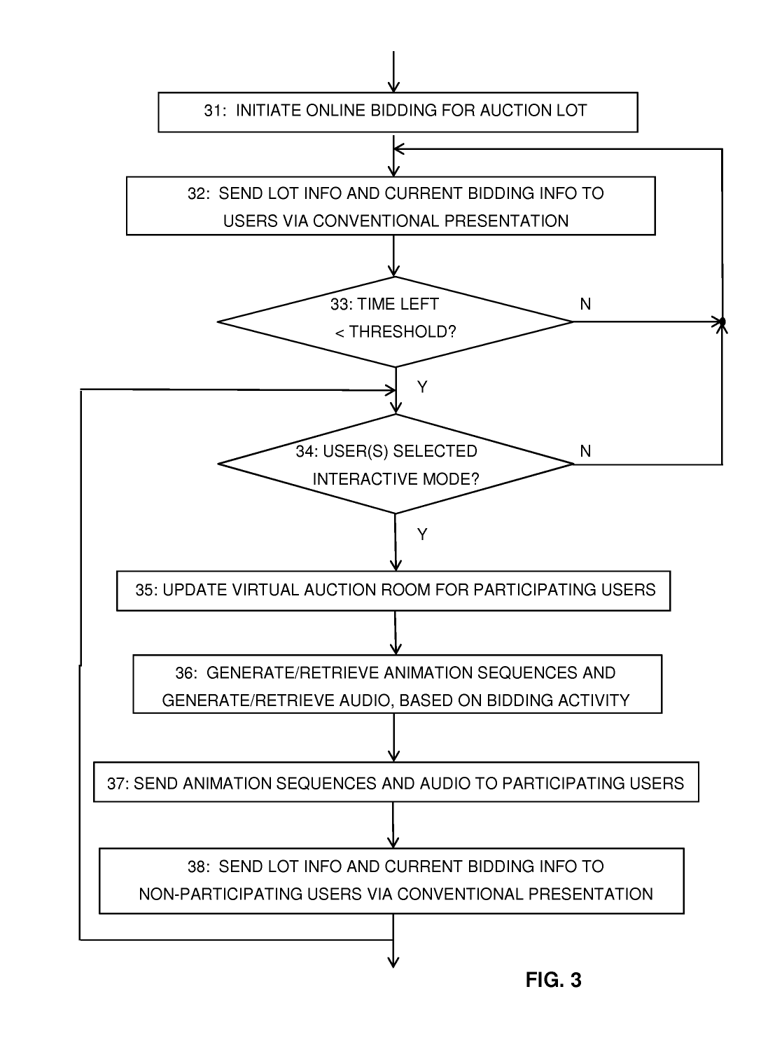

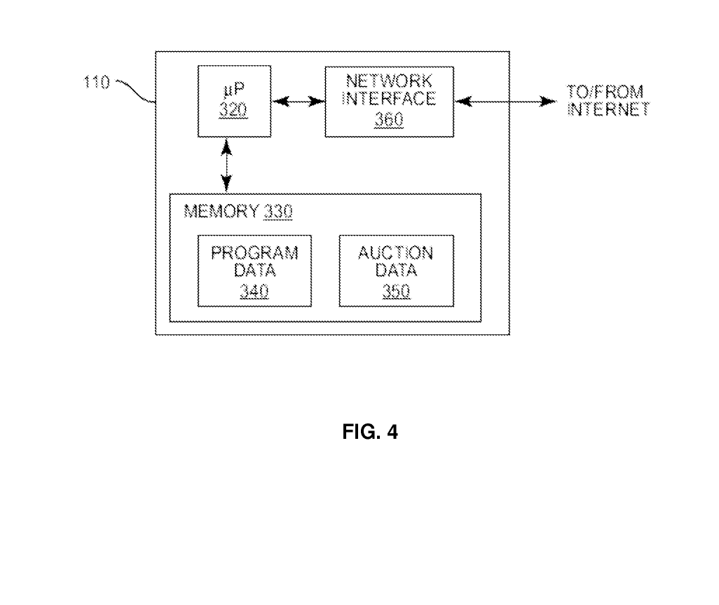

It should be understood that the specific methods and techniques taught herein can be applied in combination with the methods and apparatus described in the '145 Patent and/or in the '583 application, or can be applied to modify the methods and apparatus described in the '145 Patent or '583 application, or both. More particularly, it will be appreciated that the detailed techniques described herein may be implemented in or with the systems and apparatus described in detail in the '145 Patent. Thus, embodiments of the present invention may be implemented in a system like those illustrated in FIGS. 3 and 4 of the '145 Patent, and may include the use of one or more computer programs having a general structure the same as or similar to those described in the '145 Patent. However, said systems and computer programs are modified, according to some embodiments of the present invention, to operate according to one or more of the techniques described more fully below.

Furthermore, it should be understood that, while certain terminology used in the '145 Patent or '583 application may be used in the following detailed description, this terminology may have a modified or expanded meaning as set out in the discussion that follows. The meanings explicitly or implicitly given to terms in this detailed description shall take precedence over any contrary or more limited meanings give to the same terms in the '145 Patent or '583 application.

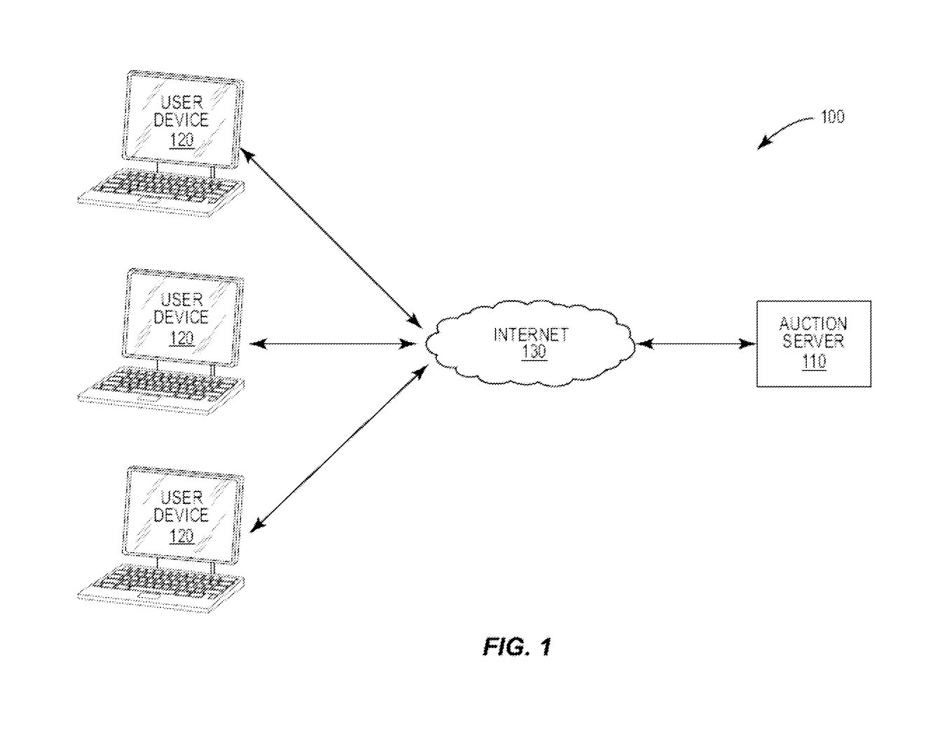

FIG. 1 illustrates an example computer network 100, comprising an auction web server 110 and several user devices (or bidder computers) 120, where the user devices 120 are linked to the auction web server 110 via the Internet 130. While three user devices 120 are illustrated, it will be appreciated that more (or fewer) user devices 120 may be linked to the auction web server 110 at any given time.

Auction web server 110, which may comprise one web server apparatus or several web servers working in tandem, is managed by an auction operator, which arranges the sale of items through an online auction service run over computer network 100 by auction web server 110. Details of the structure and configuration of an example auction web server 110 are provided below.

User devices 120 may be of any type of computing device configured to access servers through the Internet and to facilitate interactive communication with those servers by the device's user. Because of the centralized nature of the auction process, a client-server model of interaction between the user devices 120 and the auction web server 110 is generally used, where the user devices 120 act as the clients. While other approaches are possible, this client-server model of interaction may be most readily implemented through the use of web server functionality on the auction web server 110 and web browser functionality on the user devices 120, where the communications is carried out via standardized protocols such as the Hypertext Transfer Protocol (HTTP). Web browsers may be implemented on a wide variety of user devices; thus, examples of user devices or bidder computers include personal computers, tablet computers, handheld computers including so-called smartphones, and the like. While the discussion that follows may refer to bidder computers or client web browsers, or the like, it should be understood that the techniques described below may be implemented in connection with network-connected user devices more generally.

In several embodiments of the present invention, auction web server 110 is configured, e.g., with appropriate software, firmware, or the like, to communicate with bidder computers 120 via a data network, e.g., over the Internet, and to conduct an online auction in which one or more items, or “lots,” are sold in timed online auction events. It will be appreciated that two or more online auction events may be carried on simultaneously, over the same or overlapping intervals. These simultaneous online auction events may involve the same, different, or overlapping groups of bidder computers 120. Further, it will be appreciated that any given bidder computer's 120 activity and/or communications with the web server 110 may be intermittent, begin sometime after a given auction event has begun, or terminate sometime before the auction event is concluded. The particular techniques described below are designed to encourage participant interest and bidding activity as each auction event draws to a close, thus increasing the price realized by the auction for each item sold.

More particularly, several embodiments of the present invention improve the timed-online auction environment by incorporating an interactive bid mode that uses multimedia components to present a virtual auction room to a bidder via the bidder's network-connected terminal, whether that terminal is a conventional personal computer, tablet computer, smartphone, or other device. These multimedia components include animated graphics and may also include audio and/or video components.

The techniques disclosed herein can be used to create a groundbreaking online auction experience (timed/live auction hybrid) by integrating gaming elements to make timed auctions more interactive and simulate actual live on-site auctions.

Key elements of some embodiments of the present invention include:
Users may bid at a standard, non-interactive timed auction or bid in interactive mode for the same auction. The interactive mode described above is first initiated during an ongoing timed-online auction, at a predetermined time before termination of the auction event for a given lot.
Lots open and close at set time intervals and will extend based on bidding activity once interactive mode has begun.
Interactive chat between bidders may be allowed in some embodiments.
Live-auction audio based on pre-recorded increments and statements by auctioneer.
Dynamic adjustments of bid increments may be employed.
Avatar auction (bidders can create their own characters and bid in different animated environments).

In various embodiments, the virtual auction room presented to the bidder comprises one or several of the following features:
an animated depiction of an auction room, in some cases based on a user-selected “skin” or template;
an animated avatar for the bidder, i.e., a graphical representation of the bidder or the bidder's alter ego, in some cases depicted according to user-customizable physical and/or behavioral features;
animated avatars for one or more other bidders, where each avatar corresponding to a bidder raises a bid paddle or performs some other activity to indicate bidding activity by the corresponding bidder;
an animated auctioneer, coupled to either a plurality of pre-recorded audio segments that are automatically retrieved and played back in response to bidder input or coupled to synthesized audio generated in response to bidder input;
still image, video, audio, and/or textual representations of the current lot;
graphical representations and/or text indicating time left in current lot;
graphical representations and/or text indicating time or times to one or more upcoming lots and/or the items in one or more upcoming lots;
a “chat” interface providing the ability for private communication between an auction representative and a bidder, and/or communication between an auction representative and all bidders, and/or communication between two or more bidders; and
a “bid” button that, when clicked, submits a bid for the asking price on behalf of the user who initiates the request.

In some embodiments, the interactive mode described above is first initiated during an ongoing timed-online auction, at a predetermined time before termination of the auction event for a given lot. In some of these and in other embodiments, a user (bidder) is given a choice as to whether to participate in interactive mode or in a conventional online bidding mode. Accordingly, the virtual auction room interface presented to users in interactive mode may include a selector button or other input mechanism that allows the user to switch to conventional bidding mode.

Any of the embodiments summarized above may be combined with automatic bid-time extension, based on bidding activity. Likewise, any of these embodiments may also incorporate the techniques for automatic bid-increment determination described in the '583 application, e.g., so that the bidding system adjusts the increment value due to a combination of two factors: (1) how much time is left in the auction and (2) the percentage of a target price for the auctioned item represented by a most recent (i.e., “current”) bid.

For example, one embodiment of the present invention may include all of the following features. Other embodiments may omit one or more of the following or vary some of the details:
Timed-online auctions run for a set period of time (e.g., 2 weeks) and may have multiple lots in the event, which will be staggered to close at set times.
Near the conclusion of each event, the auctioneer has the ability to run a standard timed-online auction, with bidding extension features, or launch interactive mode at a set amount of time left in the auction event.
   For example, if an auction ends at 12 noon, the auctioneer can set up an interactive bidding mode to start at 9 AM with each lot closing in succession every 3 minutes.
   While interactive bidding is taking place, bidders can still place bids on all open lots that have not sold/closed, without using the interactive mode.
Bidders can choose to bid in original bidding mode or to enter the interactive bidding mode.
Details on interactive bidding mode:
   Only approved bidders are able to login to interactive bid mode. They will have the option to bid in regular mode or to launch interactive bidding.
   Once bidders launch interactive bidding, they enter a virtual auction room, i.e., the system provides their computer terminal with graphics/audio representing an auction room. Features of the room, including avatars corresponding to participating bidders, will be animated. Certain features of the virtual auction room may be user-specific, e.g., based on any of several user-selectable different “skins,” i.e., templates, for the virtual auction room.
   A participating bidder is able to select an open seat in the room, and a numbered bidder paddle is handed to the bidder's avatar.
   The main screen depicting the virtual auction room contains an animated auctioneer, an identification of the current lot being sold along with its description and images, an upcoming lot catalog, bid history, animated auction house staff, a room containing bidders, and a bid button for the bidder to use to bid.
   A countdown clock is presented when a lot opens, the countdown clock indicating the amount of time left for bidding on the lot.
   Each user sees the current price based on bids already received.
   An increment is displayed along with the asking price.
   The user is provided with pre-recorded or synthesized audio, responsive to bidding event. The pre-recorded voice may be that of the auctioneer, for example. The audio may call out the bidding increments, for instance. The auctioneer may also pre-record 15 second descriptions of each lot, for example, with this audio being presented to a participating user at the beginning of interactive mode for a given lot or upon a particular user's entry into an ongoing interactive event.
   Bid increments presented in the interactive mode are based on the auctioneers' pre-set timed increments in the system and will adjust dynamically if dynamic bid increments are set up.
   An animated auctioneer is presented to one side of an image of the lot. An interface for placing bids is presented to the user.
   When a user places a bid, the corresponding avatar's paddle will be raised in the air, and the high bidder will be highlighted.
      Users may have the ability to bid the current asking price or submit a maximum bid.
   As other users bid, each user sees the corresponding avatars' paddles going up, and the user is then outbid.
   Bid extensions are typically very short (i.e., 20 or 30 seconds) and are activated at the end of each lot.
   When a lot sells, the winning bidder receives an on-screen notification along with a sound (e.g., clapping) and/or animation to indicate the winning bid.
      The user can review his or her purchases in a My Purchases window.
   The user has the ability to view the catalog and place bids on upcoming lots while in interactive mode.
   Closing times of upcoming lots are estimated (because of bid extension that occurs on certain lots) and made available to the participating users. These closing times may be updated from time to time, based on bidding activity.
   A “chat” feature may be provided, the chat feature allowing text conversations between the auctioneer and a single bidder, the auctioneer and all bidders, and/or between bidders.
   An interface may be provided to allow the user to toggle between other open auctions and see the status of each one (e.g., Auction #1 on Lot 3, Auction # 2 on Lot 253, etc.).
   Audio and/or textual announcements, inviting the users to stay tuned for upcoming auctions, may be presented.

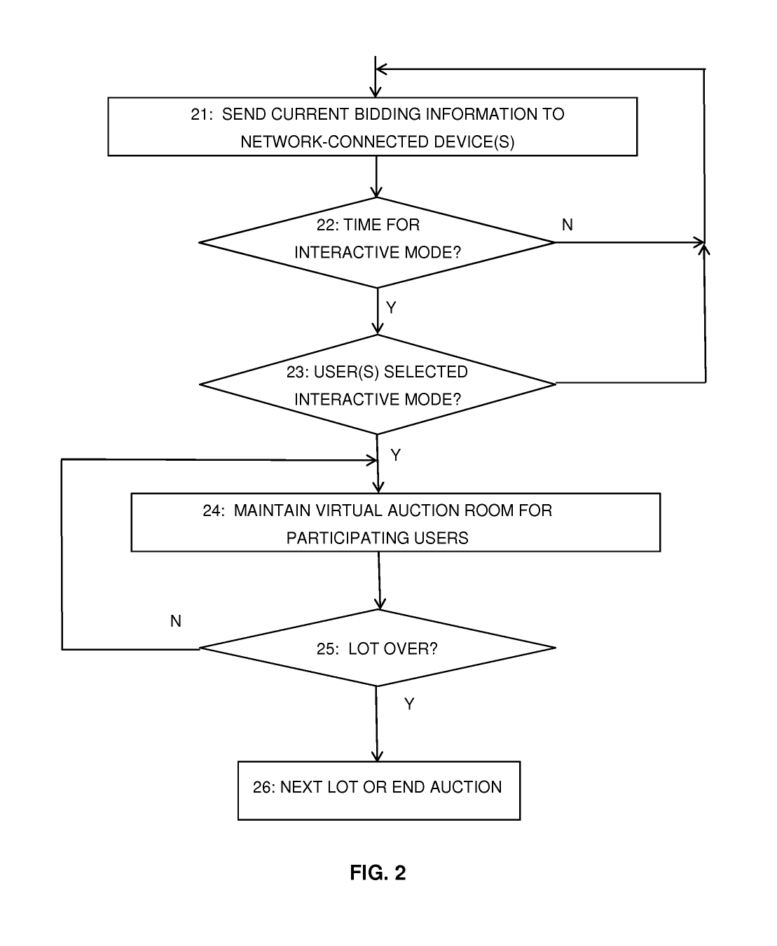

FIG. 2 illustrates an example method for conducting an online auction according to some embodiments of the invention, e.g., as might be implemented by a network-connected server apparatus. As shown at block 21, the illustrated method begins with sending current bidding information, for at least one item for sale, to the one or more network-connected user devices. This is done during an initial portion of a timed online auction event, and may be done using conventional text and/or graphics presentations.

As shown at block 22, the server determines whether a predetermined time for beginning interactive mode, i.e., a predetermined time before termination of the auction event for the item, has passed. Once that time has passed, the server determines that one or more auction users have selected to participate in an interactive mode, as indicated by the “Y” arrow leaving block 23, and then maintains a virtual auction room for participating users, as shown at block 24. This maintaining of the virtual auction room includes generating animation sequences based on bidding activity received from the participating users and sending the generated animation sequences to network-connected user devices corresponding to the participating users, and is carried out until the lot is over, as indicated at block 25. The process may be repeated for another timed lot, until the auction is over, as indicated at block 26.

In some embodiments of the illustrated method, maintaining the virtual auction room for participating users includes, in response to bid information received from a first participating user, generating an animation sequence that includes animated actions carried out by a graphical avatar corresponding to the first participating user, for sending to the network-connected user devices corresponding to the participating users. In some of these and in some other embodiments, maintaining the virtual auction room also includes generating audio data or retrieving prerecorded audio data, or both, in response to bidding activity received from the participating users, and sending the audio data to network-connected user devices corresponding to the participating users. In some embodiments, maintaining the virtual auction room for participating users may include generating a user-specific graphical representation of the virtual auction room for at least one participating user, wherein the user-specific graphical representation is based on the at least one participating user's prior selection of one of a plurality of presentation templates.

FIG. 3 illustrates another, somewhat more detailed, example method for conducting an online auction according to some embodiments of the invention, again as might be implemented by an online (i.e., network-connected) computer system such as a web server. As shown at block 31, the illustrated method begins with the initiation of online bidding for an auction lot. As noted earlier, the lot may be one of several lots in a timed online auction event, where the finishing time for each lot is staggered. In the illustrated procedure, the auctioning of the lot begins as a conventional timed online event; thus lot information, current bidding information, etc., are sent to users' terminals via conventional online auction presentations, as shown at block 32.

However, at a predetermined time before bidding on the lot is scheduled to end, the system triggers the availability of an interactive bidding mode, as shown at block 33. In the illustrated procedure, the bidding users have an option to select interactive bidding mode, as shown at block 34. If they decline to exercise that option (which may be presented to the user as a clickable “button” on the user interface presented to the user), then the conventional online auction presentation continues. If the user selects interactive mode, on the other hand, the virtual auction room is generated/updated for the participating users and sent to the participating users' terminals, as shown at block 35. As bidding activity occurs, animation sequences and/or audio are generated and/or retrieved, as shown at block 36, and sent to the participating users, as shown at block 37. Meanwhile, as shown at block 38, lot information and current bidding information continue to be sent to users who are not participating in interactive auction mode, but according to conventional online auction presentations.

It will be appreciated that the interactive auction operations shown in blocks 34 to 37 of FIG. 3 may incorporate any combination of the features described earlier, including those discussed in connection with FIG. 2. The auction processes illustrated in FIGS. 2 and 3 may also be modified to incorporate bid extensions, as suggested above, and may further incorporate automatic bid increment revisions, e.g., according to the techniques described in the '583 application.

FIG. 4 illustrates components of an example auction server 110 according to some embodiments. Server 110 comprises a microprocessor 120 coupled to a memory circuit 130 and a network interface circuit 160. Network interface circuit 160 provides connectivity to one or more client browser systems through a data network, such as the Internet, using one or more data communication standards such as Internet Protocol (IP), Transport Control Protocol (TCP), hyper-text transmission protocol (HTTP), and the like. Circuits and protocols for communicating data through a network, including the Internet, are well known, and the details of such are therefore not provided herein.

Memory circuit 130, which may include one or several types of memory such as Flash, RAM, ROM, magnetic storage devices, optical storage devices, and the like, stores program data 140, which includes computer program instructions for execution by microprocessor 120. These computer program instructions include program instructions for carrying out one or more of the techniques described above for conducting an interactive online auction. Memory circuit 150 further stores lot information, settings data (such as bid increments, etc.), graphical information for use in presenting virtual auction rooms, user profile settings (e.g., such as user-selected and/or user-designed avatars, user-selected auction room “skins,” etc.), audio data (e.g., prerecorded auctioneer words/phrases, prerecorded lot descriptions, prerecorded crowd noise and applause, etc.), and the like.

While the invention has been described in detail herein with reference to certain preferred embodiments, these embodiments have been presented by way of example only, and not to limit the scope of the invention.

What is claimed is:

1. A method for conducting an online auction, in a server apparatus configured for communication with one or more network-connected user devices, the method comprising:
sending current bidding information, for at least one item for sale, to the one or more network-connected user devices, during an initial portion of a timed online auction event; and,
beginning at a predetermined time before termination of the auction event for the item,
determining that one or more auction users have selected to participate in an interactive mode, and
maintaining a virtual auction room for participating users, said maintaining comprising generating animation sequences based on bidding activity received from the participating users and sending the generated animation sequences to network-connected user devices corresponding to the participating users.

2. The method of claim 1, wherein maintaining the virtual auction room for participating users comprises, in response to bid information received from a first participating user, generating an animation sequence that includes animated actions carried out by a graphical avatar corresponding to the first participating user, for sending to the network-connected user devices corresponding to the participating users.

3. The method of claim 1, wherein maintaining the virtual auction room comprises generating audio data or retrieving prerecorded audio data, or both, in response to bidding activity received from the participating users, and sending the audio data to network-connected user devices corresponding to the participating users.

4. The method of claim 1, further comprising continuing to send, until expiration of the auction event for the item, current bidding information to network-connected devices corresponding to auction users that have bid on the item but that have not selected to participate in the interactive mode.

5. The method of claim 1, wherein maintaining the virtual auction room for participating users comprises generating a user-specific graphical representation of the virtual auction room for at least one participating user, wherein said user-specific graphical representation is based on the at least one participating user's prior selection of one of a plurality of presentation templates.

6. The method of claim 1, further comprising comparing bids received from the participating users, during said maintaining of the virtual auction room, to one or more bids received from an auction user prior to the maintaining of the virtual auction room.

7. A server apparatus for conducting timed online auctions, the server apparatus comprising
a network interface circuit configured for communication with one or more network-connected user devices, and
a processing circuit configured to:
send current bidding information, for at least one item for sale, to the one or more network-connected user devices, during an initial portion of a timed online auction event; and,
beginning at a predetermined time before termination of the auction event for the item, determine that one or more auction users have selected to participate in an interactive mode and maintain a virtual auction room for participating users, wherein the processing circuit is configured to maintain the virtual auction room by generating animation sequences based on bidding activity received from the participating users and sending the generated animation sequences to network-connected user devices corresponding to the participating users.

8. The server apparatus of claim 6, wherein the processing circuit is configured to maintain the virtual auction room for participating users by, in response to bid information received from a first participating user, generating an animation sequence that includes animated actions carried out by a graphical avatar corresponding to the first participating user, for sending to the network-connected user devices corresponding to the participating users.

9. The server apparatus of claim 6, wherein the processing circuit is configured to maintain the virtual auction room by generating audio data or retrieving prerecorded audio data, or both, in response to bidding activity received from the participating users, and sending the audio data to network-connected user devices corresponding to the participating users.

10. The server apparatus of claim 5, wherein the processing circuit is further configured to send, until expiration of the auction event for the item, current bidding information to network-connected devices corresponding to auction users that have bid on the item but that have not selected to participate in the interactive mode.

11. The server apparatus of claim 6, wherein the processing circuit is configured to maintain the virtual auction room for participating users by generating a user-specific graphical representation of the virtual auction room for at least one participating user, based on the at least one participating user's prior selection of one of a plurality of presentation templates.

12. The server apparatus of claim 6, wherein the processing circuit is further configured to compare bids received from the participating users, during said maintaining of the virtual auction room, to one or more bids received from an auction user prior to the maintaining of the virtual auction room.
